(19) United States
(12) Patent Application Publication
(10) Pub. No.: US 2026/0241690 A1
(43) Pub. Date: Aug. 20, 2026

(54) LIQUID DISCHARGE HEAD, LIQUID DISCHARGE UNIT, AND LIQUID DISCHARGE APPARATUS

(71) Applicant: Tomoaki MURAKAMI, Kanagawa (JP)

(72) Inventor: Tomoaki MURAKAMI, Kanagawa (JP)

(21) Appl. No.: 19/534,822

(22) Filed: Feb. 10, 2026

(30) Foreign Application Priority Data
Feb. 18, 2025 (JP) 2025-024347

(51) Int. Cl. B41J 2/14; B41J 25/00

(52) U.S. Cl. CPC B41J 2/1433; B41J 2/14233; B41J 25/001; B41J 2202/11

(57) ABSTRACT

A liquid discharge head includes a nozzle plate having a first nozzle array and a second nozzle array. The first nozzle array has first nozzles to discharge liquid in a discharge direction. The second nozzle array is disposed between the first nozzle array and one edge of the nozzle plate in a first direction orthogonal to the discharge direction. The second nozzle array has second nozzles to discharge the liquid in the discharge direction. The first nozzles of the first nozzle array are: arrayed in a second direction orthogonal to the first direction and the discharge direction; and arrayed at a first nozzle density in the second direction. The second nozzles of the second nozzle array are: arrayed in the second direction; and arrayed at a second nozzle density smaller than the first nozzle density in the second direction.

### CROSS-REFERENCE TO RELATED APPLICATION

This patent application is based on and claims priority pursuant to 35 U.S.C. § 119(a) to Japanese Patent Application No. 2025-024347, filed on Feb. 18, 2025, in the Japan Patent Office, the entire disclosure of which is hereby incorporated by reference herein.

### BACKGROUND

### Technical Field

The present disclosure relates to a liquid discharge head, a liquid discharge unit, and a liquid discharge apparatus.

### Related Art

In the related art, an inkjet liquid discharge apparatus includes a liquid discharge head that discharges a liquid. The liquid discharge head includes a nozzle substrate on which multiple nozzles are arrayed, a valve to open and close the nozzle, and an actuator having a displacement mechanism to displace the valve between an open position and a closed position of the nozzle. The actuator is operated to discharge the liquid from the nozzle. An image forming system using the liquid discharge head includes a single-pass system and a multi-pass system. In the single-pass system, a recording medium is conveyed relative to a fixed head to form an image. In the multi-pass system, a recording medium is conveyed in a conveyance direction, and a head is moved in a direction orthogonal to the conveyance direction to form an image.

### SUMMARY

The present disclosure described herein provides an improved liquid discharge head including a nozzle plate having a first nozzle array and a second nozzle array. The first nozzle array has first nozzles to discharge liquid in a discharge direction. The second nozzle array is disposed between the first nozzle array and one edge of the nozzle plate in a first direction orthogonal to the discharge direction. The second nozzle array has second nozzles to discharge the liquid in the discharge direction. The first nozzles of the first nozzle array are: arrayed in a second direction orthogonal to the first direction and the discharge direction; and arrayed at a first nozzle density in the second direction. The second nozzles of the second nozzle array are: arrayed in the second direction; and arrayed at a second nozzle density smaller than the first nozzle density in the second direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic cross-sectional view of a liquid discharge head;

FIG. 2 is a schematic plan view of a nozzle array formed on a nozzle substrate according to a comparative example;

FIGS. 3A to 3C are schematic views of a liquid discharge head moving relative to a recording medium;

FIGS. 4A and 4B are schematic views of a liquid discharge head moving relative to a recording medium;

FIG. 5 is a schematic plan view of nozzles arrayed on a nozzle substrate of a liquid discharge head according to a first embodiment of the present disclosure;

FIG. 6 is a schematic plan view of nozzles arrayed on a nozzle substrate of a liquid discharge head according to a second embodiment of the present disclosure;

FIG. 7 is a schematic plan view of a nozzle substrate of a liquid discharge head according to a third embodiment of the present disclosure;

FIG. 8 is a schematic plan view of nozzles arrayed on a nozzle substrate of a liquid discharge head according to a fourth embodiment of the present disclosure;

FIG. 9 is a schematic plan view of nozzles arrayed on a nozzle substrate of a liquid discharge head according to a fifth embodiment of the present disclosure;

FIG. 10 is a schematic front view of a liquid discharge apparatus including a liquid discharge head;

FIG. 11 is a schematic plan view of a liquid discharge unit of the liquid discharge apparatus of FIG. 10, including the liquid discharge head;

FIG. 12 is a schematic plan view of another liquid discharge apparatus including a liquid discharge head;

FIG. 13 is a schematic side view of the liquid discharge apparatus of FIG. 12, including the liquid discharge head;

FIG. 14 is a schematic plan view of a liquid discharge unit of a liquid discharge apparatus including a liquid discharge head;

FIG. 15 is a schematic front view of another liquid discharge unit of a liquid discharge apparatus including a liquid discharge head; and

FIG. 16 is a schematic front view of an electrode manufacturing apparatus as a liquid discharge apparatus including a liquid discharge head.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An image forming system using a liquid discharge head includes a single-pass system and a multi-pass system. In the single-pass system, a recording medium is conveyed relative to a fixed head to form an image. In the multi-pass system, a recording medium is conveyed in a conveyance direction, and a head is moved in a direction orthogonal to the conveyance direction to form an image.

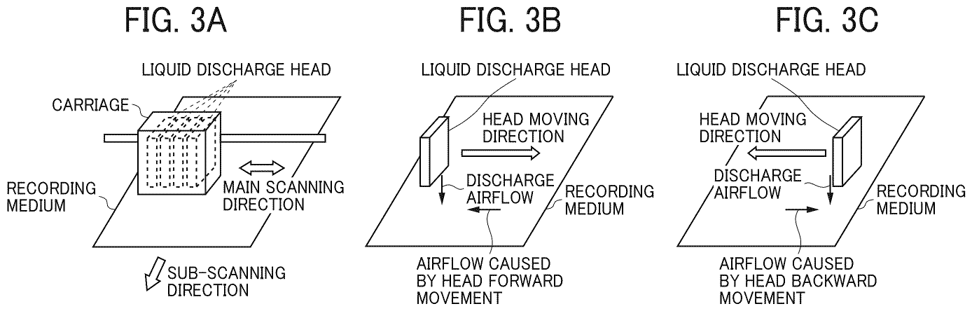

In the above-described multi-pass system, as illustrated in FIG. 3A, an image is formed while the head is reciprocated in the main scanning direction orthogonal to the sub-scanning direction relative to the recording medium conveyed in the sub-scanning direction. Accordingly, a high-density and high-quality image can be formed, and thus the multi-pass system is suitable for forming a high-quality image such as a photographic image. In such a liquid discharge head of the multi-pass system, as illustrated in FIGS. 3B and 3C, liquid discharged from the head may deviate from a desired landing position due to the influence of an airflow generated by the reciprocating motion of the head and an airflow generated by the liquid discharged from the head. As a result, image density unevenness or streaks may occur, and thus the image quality may deteriorate.

To solve the above situations, a technique is known in which a control unit controls a discharge amount of ink discharged from a downstream nozzle array to a recording medium based on a discharge density of ink discharged from an upstream nozzle array to the recording medium. The control unit controls the discharge amount of ink discharged from the downstream nozzle array based on a wraparound airflow rate indicating the degree of generation of a wraparound airflow generated by the conveyance airflow of the recording medium detouring around a self-airflow of the ink discharged from the upstream nozzle array, which is calculated based on the discharge density.

In the above-described technique, a system determines the discharge amount of the ink discharged from the downstream nozzle array based on the discharge amount discharged from the upstream nozzle array. Furthermore, when the multi-pass system forms an image, a control direction differs between the forward movement and the backward movement of the head. Accordingly, the liquid discharge head may have a very complex control mechanism.

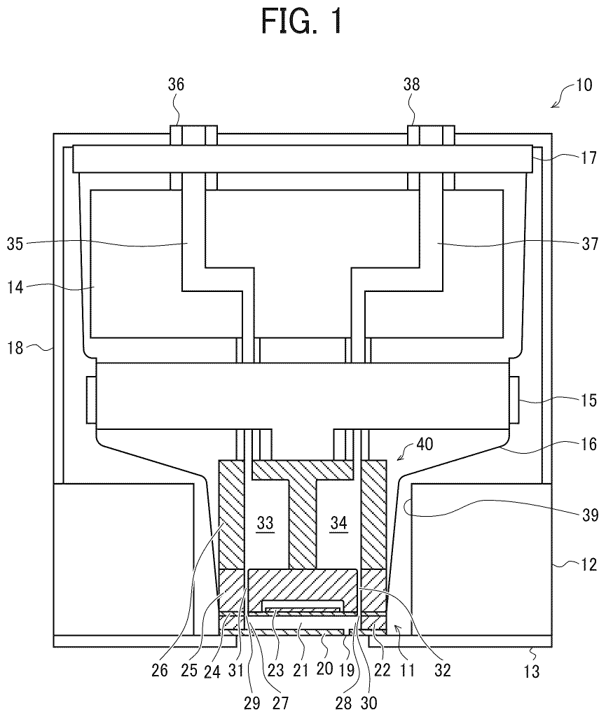

FIG. 1 is a schematic cross-sectional view of a liquid discharge unit 10 in a transverse direction of a liquid discharge head. In FIG. 1, the liquid discharge unit 10 includes multiple liquid discharge heads 11 that discharge a liquid, a base 12 that holds the multiple liquid discharge heads 11, and a cover 13 serving as a nozzle cover that covers the multiple liquid discharge heads 11. The liquid discharge unit 10 further includes a manifold 14 defining channels to supply the liquid to the multiple liquid discharge heads 11, a printed circuit board (PCB) 17 connected to a flexible wiring 16 including a driver integrated circuit (IC) 15, and a module case 18.

Each of the multiple liquid discharge heads 11 includes a nozzle substrate 20 (i.e., a nozzle plate), a channel substrate 22, a diaphragm 24, a piezoelectric element holding substrate 25, and a frame 26 as a common channel substrate. Nozzles 19 are formed in the nozzle substrate 20. The channel substrate 22 defines individual chambers 21 serving as pressure chambers communicating with the nozzles 19, respectively. The diaphragm 24 includes piezoelectric elements 23. The piezoelectric element holding substrate 25 is laminated over the diaphragm 24. The frame 26 is laminated over the piezoelectric element holding substrate 25.

A material for the nozzle substrate 20 is a single-crystal silicon wafer. In addition to the individual chambers 21, the channel substrate 22 defines supply-side individual channels 27 communicating with the individual chambers 21 and collection-side individual channels 28 communicating with the individual chambers 21, respectively.

A material for the piezoelectric element holding substrate 25 is a single-crystal silicon wafer. The piezoelectric element holding substrate 25 defines supply-side intermediate individual channels 31 and collection-side intermediate individual channels 32. The supply-side intermediate individual channels 31 communicate with the supply-side individual channels 27 via openings 29 of the diaphragm 24. The collection-side intermediate individual channels 32 communicate with the collection-side individual channels 28 via openings 30 of the diaphragm 24.

The piezoelectric element holding substrate 25 and the frame 26 define a supply-side common channel 33 and a collection-side common channel 34. The supply-side common channel 33 communicates with the supply-side intermediate individual channels 31. The collection-side common channel 34 communicates with the collection-side intermediate individual channels 32.

The supply-side common channel 33 communicates with a supply port 36 via a channel 35 of the manifold 14, and the collection-side common channel 34 communicates with a collection port 38 via a channel 37 of the manifold 14. The PCB 17 and the piezoelectric elements 23 are connected to each other via the flexible wiring 16, and the driver IC 15 is mounted on the flexible wiring 16.

In FIG. 1, components hatched with diagonal lines, such as the nozzle substrate 20, the channel substrate 22, the piezoelectric element 23, and an actuator, construct an actuator unit 40.

The multiple liquid discharge heads 11 are mounted on the base 12 at predetermined intervals. The liquid discharge head 11 is inserted into an opening 39 in the base 12, and the peripheral end of the nozzle substrate 20 of the liquid discharge head 11 is bonded and fixed to the cover 13, which is bonded and fixed to the base 12, to attach the liquid discharge head 11 to the base 12.

A flange disposed outside the frame 26 of the liquid discharge head 11 is bonded and fixed to the base 12. A structure for fixing the liquid discharge head 11 to the base 12 is not limited to the above-described structure. The liquid discharge head 11 may be fixed to the base 12 by, for example, bonding, swaging, riveting, or screwing. In this configuration, the liquid discharge head 11 is reciprocally moved in a direction parallel to the main scanning direction by a moving mechanism that will be described later.

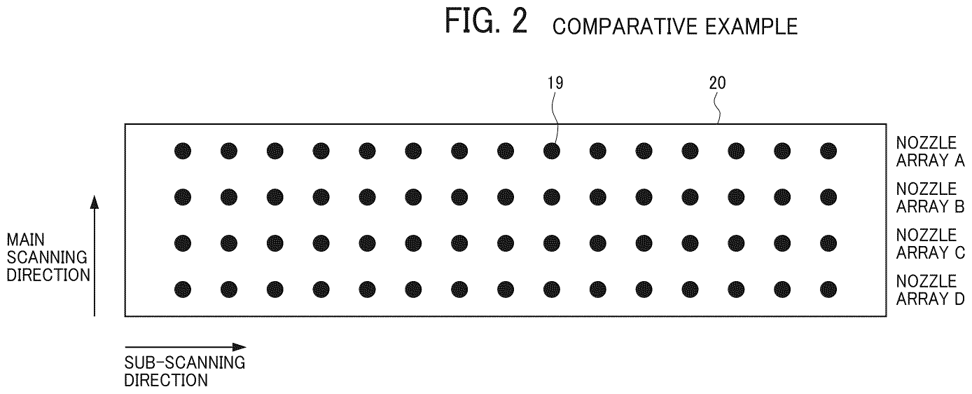

FIG. 2 illustrates the arrangement of nozzles 19 formed on a nozzle substrate 20 according to a comparative example. The nozzle substrate 20 according to the comparative example has multiple nozzle arrays including multiple nozzles 19 arrayed in parallel with the sub-scanning direction, which is the conveyance direction of the recording medium, and the multiple nozzle arrays (in FIG. 2, four rows of a nozzle array A, a nozzle array B, a nozzle array C, and a nozzle array D) are arrayed in the main scanning direction, which is orthogonal to the sub-scanning direction.

The multi-pass system is described above, and the liquid discharge head 11 including the nozzle substrate 20 illustrated in FIG. 2 will be described below.

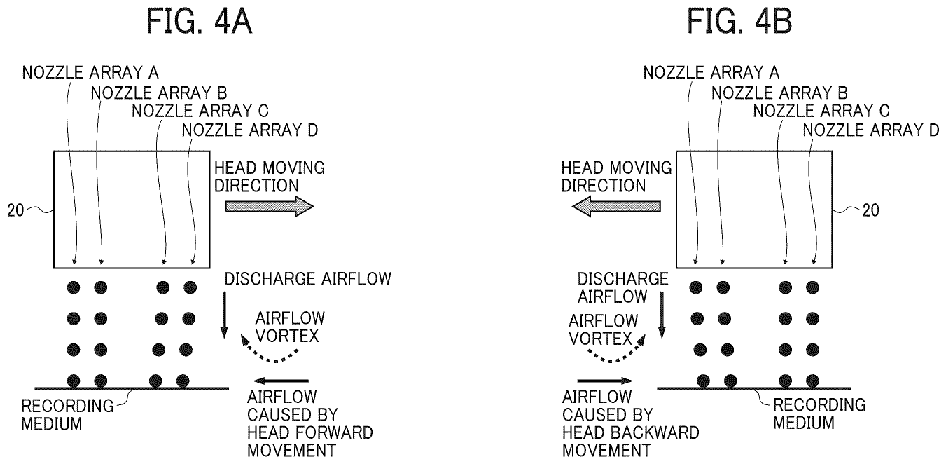

FIGS. 4A and 4B are schematic views of the liquid discharge head 11 including the nozzle substrate 20, illustrating an influence of airflow. In an ideal state, the movement of the liquid discharge head 11 does not generate any airflow, and the ink discharged from each nozzle 19 lands vertically on the recording medium. However, in an actual apparatus, as illustrated in FIGS. 4A and 4B, an airflow caused by the movement of the head interferes with a discharge airflow caused by ink droplets flying in the upstream space of the head to generate an airflow vortex. Consequently, the ink discharged from each nozzle 19 lands at a position deviated from the ideal landing position. The airflow caused by the movement of the head affects the nozzle array D formed on the nozzle substrate 20 in the forward movement of the liquid discharge head 11 and affects the nozzle array A in the backward movement of the liquid discharge head 11.

To solve the above-described situations, the nozzle density on the upstream side in the direction of the airflow caused by the movement of the head is lower than that on the downstream side against the influence of the airflow vortex to reduce the discharge airflow on the upstream side. As a result, the interference between the airflow caused by the movement of the head and the discharge airflow on the upstream side is prevented, a landing position deviation is reduced, and thus a high-quality image is formed. Furthermore, to prevent the interference of the airflow in both the forward movement and the backward movement of the head, the nozzle density of the outer nozzle arrays (i.e., the nozzle array A and the nozzle array D in FIGS. 4A and 4B) located on the outer side of the nozzle substrate is decreased. With this configuration, the landing position deviation of ink droplets on the recording medium can be reduced in both the forward movement and the backward movement without complicating the drive control mechanism of the liquid discharge head, resulting in high-quality images. A description is given below of the arrangement of nozzles on a nozzle substrate with reference to the drawings.

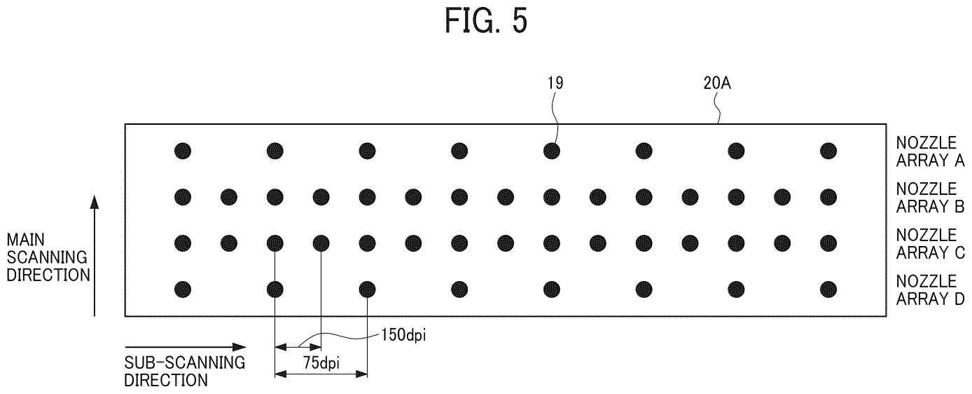

FIG. 5 illustrates a nozzle substrate 20A according to a first embodiment of the present disclosure. The nozzle substrate 20A attached to the liquid discharge head 11 is different from the nozzle substrate 20 illustrated in FIG. 2 in that the arrangement position of the nozzles 19 is different.

The nozzle substrate 20A has multiple nozzle arrays each including multiple nozzles 19 arrayed in parallel with the sub-scanning direction, and the multiple nozzle arrays (in FIG. 5, four rows of a nozzle array A, a nozzle array B, a nozzle array C, and a nozzle array D) are arrayed in the main scanning direction orthogonal to the sub-scanning direction. Among the nozzle arrays A to D, the nozzle arrays A and D located on an outer portion of the nozzle substrate 20A in the main scanning direction are defined as outer nozzle arrays, and the nozzle arrays B and C located on an inner portion of the nozzle substrate 20A in the main scanning direction are defined as inner nozzle arrays.

In other words, the nozzle substrate 20A has multiple nozzle arrays arrayed in a first direction (e.g., the main scanning direction) to discharge liquid in a discharge direction orthogonal to the first direction. Each of the multiple nozzle arrays extends in a second direction (e.g., the sub-scanning direction) orthogonal to the first direction and the discharge direction. The multiple nozzle arrays include a first nozzle array (e.g., the nozzle array B or C) between a center line of the nozzle substrate 20A and one edge of the nozzle substrate 20A in the first direction and a second nozzle array (e.g., the nozzle array A or D) between the first nozzle array and the one edge of the nozzle substrate 20A in the first direction.

In the configuration illustrated in FIG. 5, the nozzles 19 in the nozzle arrays B and C, which are the inner nozzle, have the nozzle density corresponding to the resolution of a desired image to be formed. For example, the resolution of the image formed by the inner nozzle arrays is 150 dots per inch (dpi) in FIG. 5. On the other hand, the nozzles 19 in the nozzle arrays A and D, which are the outer nozzle arrays, have the nozzle density equal to ½ of the nozzle density of the inner nozzle arrays, which corresponds to a resolution of 75 dpi of the image formed by the outer nozzle arrays.

In other words, the first nozzle array has first nozzles arrayed at a first nozzle density in the second direction, and the second nozzle array has second nozzles arrayed at a second nozzle density smaller than the first nozzle density in the second direction.

With this configuration, the number of nozzles 19 that discharge ink is reduced. Accordingly, the discharge airflow is reduced, the airflow vortex is prevented, and thus an image with good image quality can be obtained. As a result, a liquid discharge head can be provided that reduces variations in the landing position of ink due to the influence of airflow, regardless of the moving direction of the head.

Further, the multiple nozzle arrays are symmetric with respect to the center line of the nozzle substrate in the first direction.

In other words, the nozzle substrate 20A further has a third nozzle array between the first nozzle array and another edge of the nozzle plate in the first direction. The third nozzle array having third nozzles to discharge the liquid in the discharge direction. The third nozzles of the third nozzle array are: arrayed in the second direction; and arrayed at a third nozzle density equal to the second nozzle density in the second direction. The first nozzle array and the third nozzle array are symmetric with respect to a center line: disposed at a center of the nozzle substrate 20A in the first direction; and extending in the second direction.

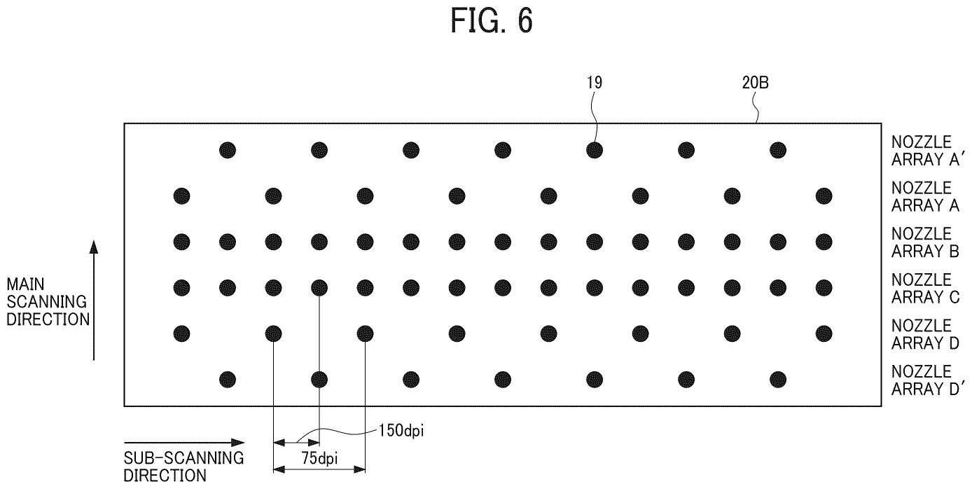

FIG. 6 illustrates a nozzle substrate 20B according to a second embodiment of the present disclosure. The nozzle substrate 20B attached to the liquid discharge head 11 is different from the nozzle substrate 20A illustrated in FIG. 5 in that the nozzle substrate 20B has nozzle arrays A′ and D′ as other outer nozzle arrays outside the nozzle arrays A and D as the outer nozzle arrays.

The nozzle array A′ has the nozzles 19 having the nozzle density, which is the same as that of the nozzle array A, corresponding to the resolution of 75 dpi. In the nozzle array A′, the nozzles 19 are arrayed at positions corresponding to the positions of the nozzles 19 excluded from the nozzle array B in the nozzle array A, i.e., the positions where the nozzles 19 are not arrayed in the nozzle array A, in the sub-scanning direction. The nozzle array D′ has the nozzles 19 having the nozzle density, which is the same as that of the nozzle array C, corresponding to the resolution of 75 dpi. In the nozzle array D′, the nozzles 19 are arrayed at positions corresponding to the positions of the nozzles 19 excluded from the nozzle array C in the nozzle array D, i.e., the positions where the nozzles 19 are not arrayed in the nozzle array D, in the sub-scanning direction.

In other words, the multiple nozzle arrays further include a third nozzle array (e.g., the nozzle array A′ or D′) between the second nozzle array and the edge of the nozzle substrate in the first direction. The third nozzle array has the third nozzles arrayed at a third nozzle density equal to the second nozzle density in the second direction, and the third nozzles are shifted from the second nozzles in the second direction.

With this configuration, the same functional effect as the first embodiment can be obtained, the resolution of the entire liquid discharge head 11 can be secured, and thus an image with good image quality can be obtained.

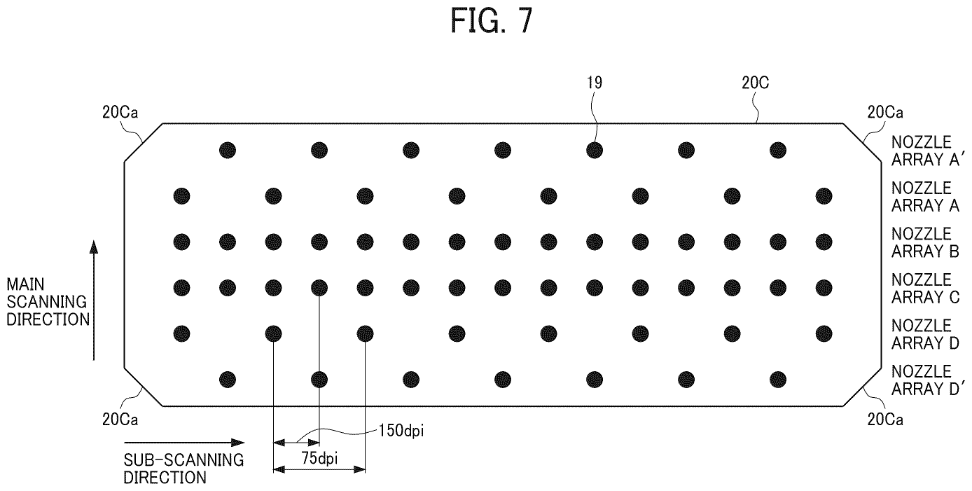

FIG. 7 illustrates a nozzle substrate 20C according to a third embodiment of the present disclosure. The nozzle substrate 20C attached to the liquid discharge head 11 is different from the nozzle substrate 20B illustrated in FIG. 6 in that the nozzle substrate 20C has a rectangular shape with each corner C-chamfered (i.e., chamfered corners 20Ca in FIG. 7).

With this configuration, the liquid discharge head 11 that is reciprocally moved is streamlined as compared with the first and second embodiments with respect to the moving direction. Accordingly, the airflow due to the movement of the head is reduced, the airflow vortex is prevented, and thus an image with good image quality can be obtained. The chamfered corner 20Ca may be R-chamfered (rounded) instead of C-chamfered. The R-chamfered corner can reduce the air resistance and can further prevent the generation of the airflow as compared with the C-chamfered corner.

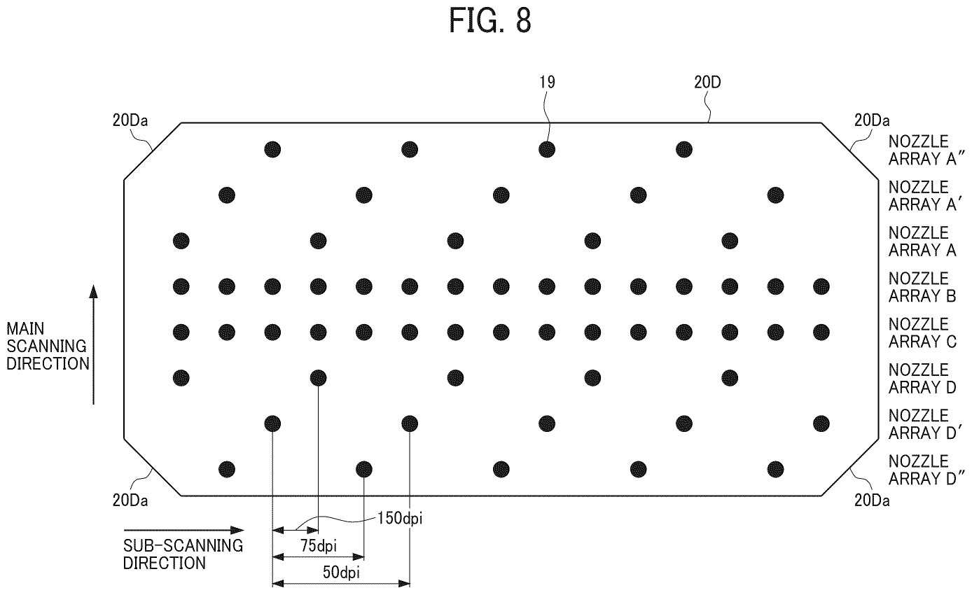

FIG. 8 illustrates a nozzle substrate 20D according to a fourth embodiment of the present disclosure. The nozzle substrate 20D attached to the liquid discharge head 11 is different from the nozzle substrate 20C illustrated in FIG. 7 in that the nozzle substrate 20D has nozzle arrays A″ and D″ as still other outer nozzle arrays outside the nozzle arrays A′ and D′ as other outer nozzle arrays.

Further, the nozzle substrate 20D is different from the nozzle substrate 20C in that the nozzles 19 in the nozzle arrays A, A′, A″, D, D′, and D″ have the nozzle density equal to ⅓ of the nozzle density of the nozzles 19 in the nozzle arrays B and C, and the nozzle substrate 20D has a rectangular shape with each corner C-chamfered (i.e., chamfered corners 20Da in FIG. 8).

The nozzle array A has the nozzles 19 having the nozzle density, which is equal to ⅓ of the nozzle density of the nozzle array B, corresponding to the resolution of 50 dpi. In the nozzle array A, the nozzles 19 are arrayed at positions corresponding to the positions of the nozzles 19 of the nozzle array B from which two of every three nozzles 19 arrayed in series are excluded in the sub-scanning direction. The nozzle array A′ has the nozzles 19 having the nozzle density, which is the same as that of the nozzle array A, corresponding to the resolution of 50 dpi. In the nozzle array A′, the nozzles 19 are arrayed at positions corresponding to the positions of upstream one of the two excluded nozzles 19 from the nozzle array B in the nozzle array A in the sub-scanning direction. The nozzle array A″ has the nozzles 19 having the nozzle density, which is the same as that of the nozzle array A, corresponding to the resolution of 50 dpi. In the nozzle array A″, the nozzles 19 are arrayed at positions corresponding to the positions of downstream one of the two excluded nozzles 19 from the nozzle array B in the nozzle array A in the sub-scanning direction.

The nozzle array D has the nozzles 19 having the nozzle density, which is equal to ⅓ of the nozzle density of the nozzle array C, corresponding to the resolution of 50 dpi. In the nozzle array D, the nozzles 19 are arrayed at positions corresponding to the positions of the nozzles 19 of the nozzle array C from which two of every three nozzles 19 arrayed in series are excluded in the sub-scanning direction. The nozzle array D′ has the nozzles 19 having the nozzle density, which is the same as that of the nozzle array D, corresponding to the resolution of 50 dpi. In the nozzle array D′, the nozzles 19 are arrayed at positions corresponding to the positions of downstream one of the two excluded nozzles 19 from the nozzle array C in the nozzle array D in the sub-scanning direction. The nozzle array D″ has the nozzles 19 having the nozzle density, which is the same as that of the nozzle array D, corresponding to the resolution of 50 dpi. In the nozzle array D″, the nozzles 19 are arrayed at positions corresponding to the positions of upstream one of the two excluded nozzles 19 from the nozzle array C in the nozzle array D in the sub-scanning direction.

In the fourth embodiment, the nozzles 19 in the nozzle array A, which is the outer nozzle array, has the nozzle density equal to ⅓ of the nozzle density of the nozzles 19 in the nozzle array B, which is the inner nozzle array, and two rows of the other outer nozzle arrays A′ and A″ are disposed outside the outer nozzle array A. The same applies to the nozzle arrays D′ and D″.

The nozzle substrate 20D has a rectangular shape with each corner C-chamfered (i.e., the chamfered corners 20Da). The chamfered corner 20Da has a width larger than the width of the chamfered corner 20Ca illustrated in the third embodiment. In this example, the chamfered corner 20Da has 1.5 times that of the chamfered corner 20Ca. The chamfered corner 20Da may be R-chamfered (rounded).

In other words, the nozzle substrate 20D further has a (n+1)th nozzle array (i.e., the nozzle array A″). The (n+1)th nozzle array is disposed between the third nozzle array and the one edge of the nozzle substrate 20D in the first direction. The (n+1)th nozzle array has a (n+1)th nozzle density equal to: 1/n of the first nozzle density; and the second nozzle density and the third nozzle density. A width of the chamfered corners increases in proportion to n, where n is an integer larger than two. The first nozzle density is equal to a resolution of an image to be formed on a medium.

With this configuration, since the size (width) of the chamfered corner 20Da increases in proportion to the number of other outer nozzle arrays, the liquid discharge head 11 that is reciprocally moved is further streamlined as compared with the first to third embodiments with respect to the moving direction. Accordingly, the airflow due to the movement of the head is further reduced, the airflow vortex is prevented, and thus an image with good image quality can be obtained.

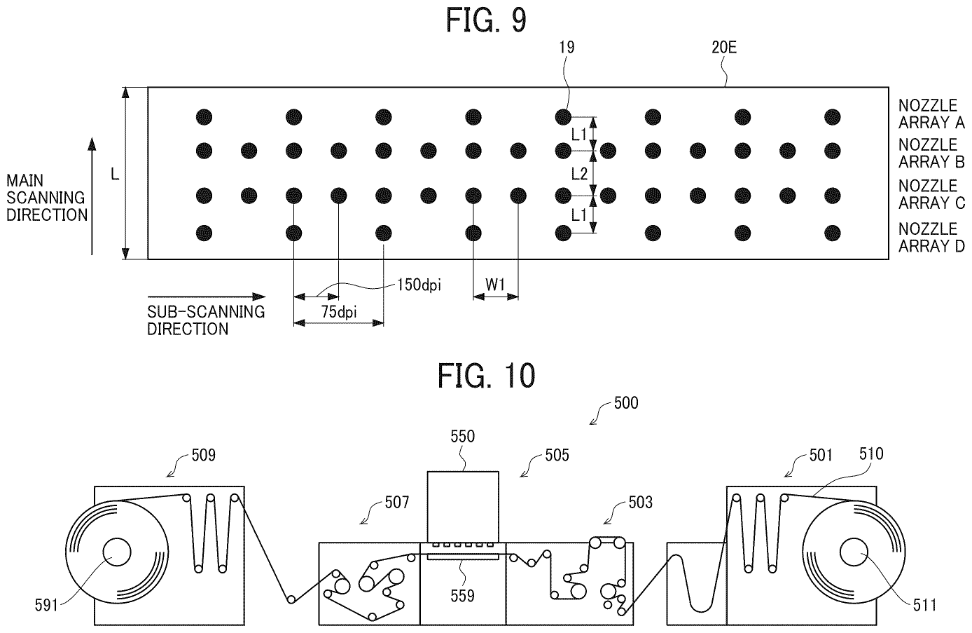

FIG. 9 illustrates a nozzle substrate 20E according to a fifth embodiment of the present disclosure. The nozzle substrate 20E attached to the liquid discharge head 11 is different from the nozzle substrate 20A illustrated in FIG. 5 in that gaps L1 between the nozzle arrays A and B and between the nozzle arrays C and D are narrower than an interval W1 between the nozzles 19 in the nozzle arrays B and C. The nozzle arrays A and D are the outer nozzle arrays, and the nozzle arrays B and C are the inner nozzle arrays. The interval W1 is the same as the interval between the nozzles 19 having the nozzle density corresponding to the resolution of 150 dpi. A gap L2 between the nozzle arrays B and C is the same as the interval W1.

In other words, the second nozzle array is spaced apart from the first nozzle array, in the first direction, by a gap narrower than an interval between the first nozzles in the second direction.

With this configuration, even when the gap L1 is smaller than the interval W1, since the nozzle density of the outer nozzle arrays is lower than the nozzle density of the inner nozzle array, the airflow vortex can be prevented, and a high-quality image can be obtained. Further, a length L of the nozzle substrate 20E can be smaller than that of the nozzle substrate 20A, and thus the liquid discharge head 11 can be downsized.

A description is given below of a liquid discharge apparatus including the liquid discharge head 11 described above.

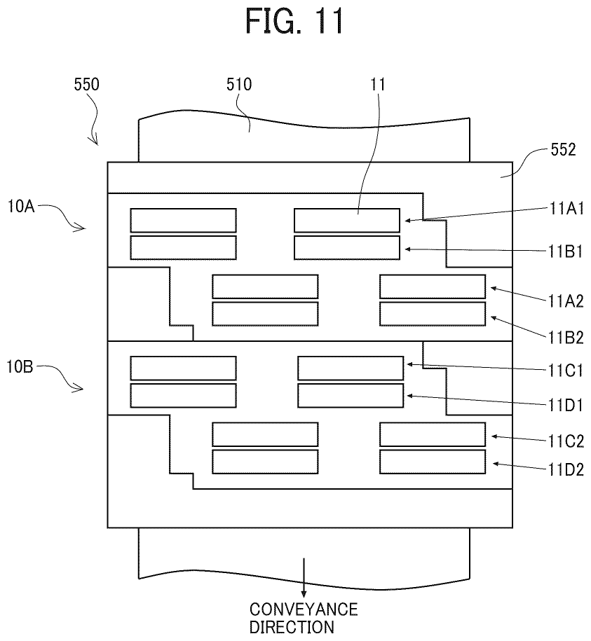

As illustrated in FIGS. 10 and 11, a printer 500 serving as the liquid discharge apparatus includes a feeder 501 to feed a continuous medium 510 as a recording medium, a guide conveyor 503 to guide and convey the continuous medium 510, fed from the feeder 501, to a printing unit 505. The printer 500 further includes the printing unit 505 to discharge a liquid onto the continuous medium 510 to form an image on the continuous medium 510, a dryer 507 to dry the continuous medium 510 to which the liquid adheres, and a carrier 509 to feed the dried continuous medium 510 outward.

The continuous medium 510 is fed from a winding roller 511 of the feeder 501, guided and conveyed with rollers of the feeder 501, the guide conveyor 503, the dryer 507, and the carrier 509, and wound around a take-up roller 591 of the carrier 509. These rollers serve as a conveyor to convey the continuous medium 510.

In the printing unit 505, the continuous medium 510 is conveyed on a conveyance guide 559 so as to face a head unit 550 as a liquid discharge unit. The head unit 550 discharges a liquid onto the continuous medium 510 to print an image.

The printer 500 includes liquid discharge units 10A and 10B, which are similar to the above-described liquid discharge unit 10, in the head unit 550. The liquid discharge units 10A and 10B are mounted on a common base 552.

The liquid discharge unit 10A includes head arrays 11A1, 11B1, 11A2, and 11B2. Each of the head arrays 11A1, 11B1, 11A2, and 11B2 includes liquid discharge heads 11 arranged in a head array direction perpendicular to a conveyance direction of the continuous medium 510. The liquid discharge unit 10B includes head arrays 11C1, 11D1, 11C2, and 11D2. Each of the head arrays 11C1, 11D1, 11C2, and 11D2 includes liquid discharge heads 11 arranged in the head array direction. The head arrays 11A1 and 11A2 of the liquid discharge unit 10A discharge liquid of the same color. Similarly, the head arrays 11B1 and 11B2 of the liquid discharge unit 10A are grouped as one set and discharge liquid of the same desired color. The head arrays 11C1 and 11C2 of the liquid discharge unit 10B are grouped as one set and discharge liquid of the same desired color. The head arrays 11D1 and 11D2 of the liquid discharge unit 10B are grouped as one set and discharge liquid of the same desired color.

Even in the printer 500 of the single-pass system, instead of the airflow due to the movement of the head, the interference between an airflow due to the conveyance of the recording medium (e.g., the continuous medium 510) and the discharge airflow is reduced, the airflow vortex is prevented, and thus an image with good image quality can be obtained.

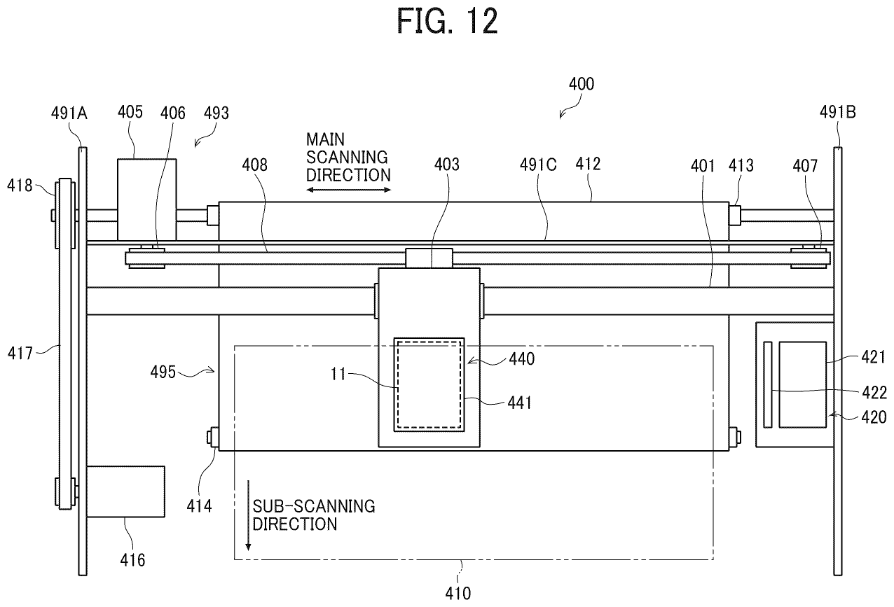

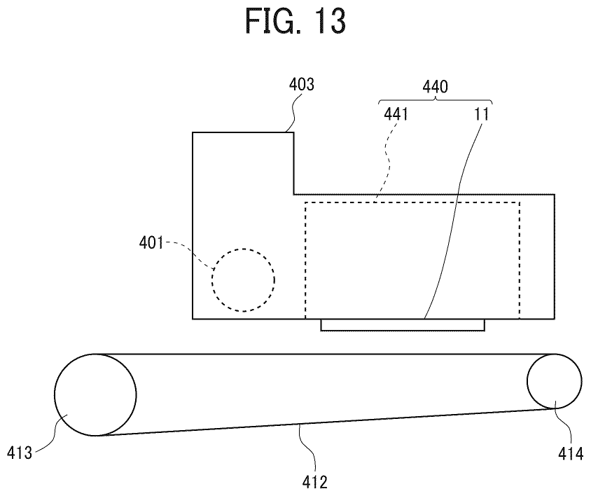

Another printer 400 as a liquid discharge apparatus is described below with reference to FIGS. 12 and 13.

As the liquid discharge apparatus and an image forming apparatus, the printer 400 is a serial type printing apparatus (i.e., the multi-pass system), and a main-scanning moving mechanism 493 reciprocally moves a carriage 403 in the main scanning direction.

The main-scanning moving mechanism 493 includes a guide 401, a main scanning motor 405, and a timing belt 408. The guide 401 is bridged between left and right side plates 491A and 491B to movably hold the carriage 403. The carriage 403 is reciprocally moved in the main scanning direction by driving force of the main scanning motor 405 transmitted via the timing belt 408 looped around a drive pulley 406 and a driven pulley 407.

The carriage 403 mounts a liquid discharge unit 440 including the liquid discharge head 11 and a head tank 441 as a single integrated unit. The liquid discharge head 11 discharges color liquids of, for example, yellow (Y), cyan (C), magenta (M), and black (K). The liquid discharge head 11 is mounted on the liquid discharge unit 440 such that a nozzle array including the multiple nozzles is arranged in the sub-scanning direction perpendicular to the main scanning direction. The liquid discharge head 11 discharges the color liquid downward from the multiple nozzles. The liquid discharge head 11 is coupled to a liquid circulation device so that a liquid of a desired color is circulated and supplied to the liquid discharge head 11.

The printer 400 includes a conveyance mechanism 495 to convey a sheet 410 as the recording medium. The conveyance mechanism 495 includes a conveyance belt 412 as a conveyor and a sub-scanning motor 416 to drive the conveyance belt 412. The conveyance belt 412, which is an endless belt, is stretched between a conveyance roller 413 and a tension roller 414, and conveys the sheet 410 at a position facing the liquid discharge head 11 while attracting the sheet 410. The sheet 410 can be attracted to the conveyance belt 412 by, for example, electrostatic attraction or air suction. The conveyance belt 412 is circumferentially moved in the sub-scanning direction by driving force of the sub-scanning motor 416 transmitted via a timing belt 417 and a timing pulley 418.

On one end of the range of movement of the carriage 403 in the main scanning direction, a maintenance mechanism 420 that maintains and recovers the liquid discharge head 11 is disposed lateral to the conveyance belt 412. The maintenance mechanism 420 includes, for example, a cap 421 to cap a nozzle face (i.e., a face on which the multiple nozzles are formed) of the liquid discharge head 11 and a wiper 422 to wipe the nozzle face. The main-scanning moving mechanism 493, the maintenance mechanism 420, and the conveyance mechanism 495 are mounted onto a housing including the side plates 491A and 491B and a back plate 491C.

In the printer 400 having the above-described configuration, the sheet 410 is attracted on the conveyance belt 412 and conveyed in the sub-scanning direction by the circumferential movement of the conveyance belt 412. The liquid discharge head 11 is driven in response to an image signal while the carriage 403 moves in the main scanning direction to discharge a liquid onto the sheet 410 not in motion. As a result, an image is formed on the sheet 410.

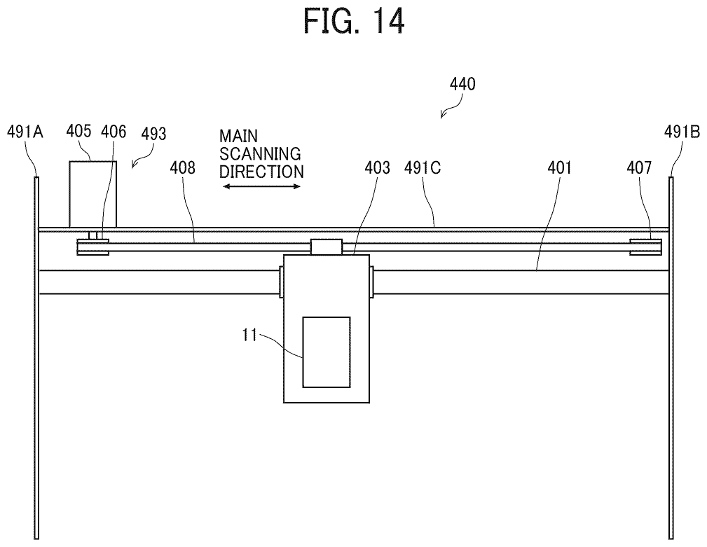

The above-described liquid discharge unit 440 is described below with reference to FIG. 14.

The liquid discharge unit 440 includes the housing, the main-scanning moving mechanism 493, the carriage 403, and the liquid discharge head 11 among components of the printer 400 as the liquid discharge apparatus and the image forming apparatus. The side plates 491A and 491B, and the back plate 491C construct the housing.

In the liquid discharge unit 440, the maintenance mechanism 420 described above may be mounted on, for example, the side plate 491B.

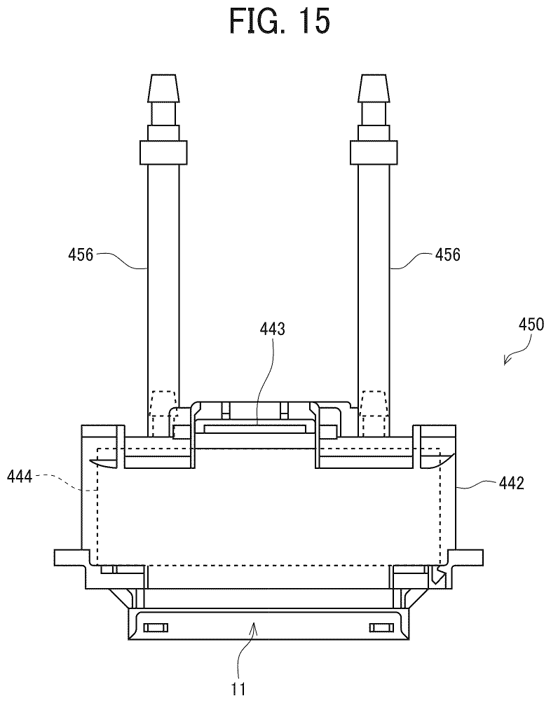

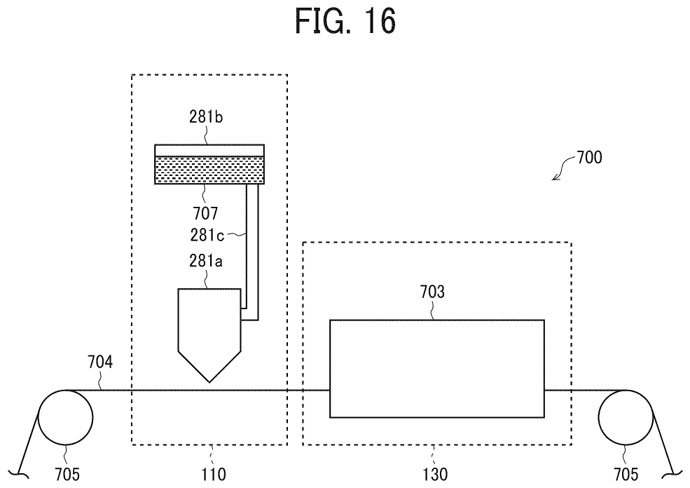

Another liquid discharge unit 450 is described below with reference to FIG. 15.

The liquid discharge unit 450 illustrated in FIG. 15 includes the liquid discharge head 11 to which a channel component 444 is attached, and a tube 456 connected to the channel component 444. The channel component 444 is disposed inside a cover 442, and a connector 443 for electrically connecting to the liquid discharge head 11 is disposed on an upper portion of the channel component 444. In some embodiments, the liquid discharge unit 440 may include the head tank 441 instead of the channel component 444.

Each of the liquid discharge units 10, 10A, 10B, 440, 450, and 550 and each of the printers 400 and 500 as the liquid discharge apparatus, which includes the liquid discharge head 11 described above, can attain the same operational effects as the operational effects of the liquid discharge head 11 described above.

In the present disclosure, the liquid to be used is not limited to a particular liquid as long as the liquid has a viscosity or surface tension to be discharged from a head (liquid discharge head). However, preferably, the viscosity of the liquid is not greater than 30 millipascal-second (mPa·s) under ordinary temperature and ordinary pressure or by heating or cooling. Examples of the liquid include a solution, a suspension, or an emulsion that contains, for example, a solvent, such as water or an organic solvent; a colorant, such as dye or pigment; a functional material, such as a polymerizable compound, a resin, or a surfactant; a biocompatible material, such as deoxyribonucleic acid (DNA), amino acid, protein, or calcium; or an edible material, such as a natural colorant. Such a solution, a suspension, or an emulsion can be used for, e.g., inkjet ink, surface treatment solution, or a material solution for three-dimensional fabrication.

Examples of an energy source for generating energy to discharge liquid include a piezoelectric actuator (a laminated piezoelectric element or a thin-film piezoelectric element), a thermal actuator that employs a thermoelectric transducer, such as a thermal resistor, and an electrostatic actuator including a diaphragm and opposed electrodes.

The pressure generator used in the liquid discharge head is not limited to a particular type of pressure generator. In addition to the above-described piezoelectric actuator (which may use a laminated piezoelectric element), for example, a thermal actuator using a thermoelectric transducer such as a thermal resistor, and an electrostatic actuator including a diaphragm and opposed electrodes can be used.

The “liquid discharge unit” is an assembly of parts relating to liquid discharge. The term “liquid discharge unit” represents a structure including the liquid discharge head and a functional component(s) or mechanism(s) combined with the liquid discharge head as a single unit. For example, the “liquid discharge unit” includes a combination of the liquid discharge head with at least one of a head tank, a carriage, a supply mechanism, a maintenance mechanism, a main-scanning moving mechanism, or a liquid circulation device.

The above integration may be achieved by, for example, a combination in which the liquid discharge head and a functional part(s) are secured to each other through, e.g., fastening, bonding, or engaging, and a combination in which one of the liquid discharge head and a functional part(s) is movably held by another. The liquid discharge head may be detachably attached to the functional part(s) or mechanism(s) each other.

The liquid discharge head and the head tank may be assembled, or the liquid discharge head and the head tank may be coupled (connected) to each other via, for example, a tube to form the liquid discharge unit as a single unit. A unit including a filter may further be added to a portion between the head tank and the liquid discharge head of the liquid discharge unit.

The liquid discharge unit may be an integrated unit in which the liquid discharge head and the carriage are integrated as a single unit, or the liquid discharge head, the carriage, and the main-scanning moving mechanism are integrated as a single unit. As yet another example, the liquid discharge unit is a unit in which the liquid discharge head and the scanning moving mechanism are combined into a single unit. The liquid discharge head is movably held by a guide that is a part of the scanning moving mechanism.

In another example, the cap that forms a part of the maintenance mechanism is fixed to the carriage mounting the liquid discharge head so that the liquid discharge head, the carriage, and the maintenance mechanism are integrated as a single unit to form the liquid discharge unit. Further, in another example, the liquid discharge unit includes a tube connected to the liquid discharge head mounting the head tank or the channel component so that the liquid discharge head and the supply mechanism are integrated as a single unit. Through the tube, the liquid in a liquid storage source is supplied to the liquid discharge head.

The main-scanning moving mechanism may be a guide only. The supply mechanism may be a tube(s) only or a loading unit only.

Although the liquid discharge unit includes the liquid discharge head as described above, examples of the liquid discharge unit include a head module and the head unit including the above-described liquid discharge head, with which the above-described functional components or mechanisms are combined to form a single unit.

The liquid discharge apparatus used herein also represents a liquid discharge apparatus including the liquid discharge head, the liquid discharge unit, the head module, or the head unit to drive the liquid discharge head to discharge liquid. The liquid discharge apparatus used herein includes, in addition to apparatuses to discharge liquid to a medium onto which liquid can adhere, apparatuses to discharge the liquid into gas (air) or a different liquid.

The liquid discharge apparatus may further include devices relating to feeding, conveying, and ejecting of the medium onto which liquid can adhere and also include a pretreatment device and an aftertreatment device.

The liquid discharge apparatus may be, for example, an image forming apparatus to form an image on a recording medium by discharging ink, or a three-dimensional fabrication apparatus to discharge fabrication liquid to a powder layer in which powder material is formed in layers to form a three-dimensional object.

The liquid discharge apparatus is not limited to an apparatus that discharges liquid to visualize meaningful images such as letters or figures. For example, the liquid discharge apparatus may be an apparatus that forms patterns having no meaning or an apparatus that fabricates three-dimensional images.

The medium onto which liquid can adhere described above represents a medium onto which liquid is at least temporarily adhered, a medium onto which liquid is adhered and fixed, or a medium into which liquid adheres and permeates. Examples of the medium onto which liquid can adhere include recording medium, such as paper sheet, recording paper, recording sheet of paper, film, and cloth, electronic components, such as electronic substrate and piezoelectric element, and media, such as powder layer, organ model, and testing cell. The medium onto which liquid can adhere includes any medium to which liquid adheres, unless otherwise specified.

Examples of the material for the medium onto which liquid can adhere include any materials to which liquid can adhere even temporarily, such as paper, thread, fiber, fabric, leather, metal, plastic, glass, wood, and ceramic.

Examples of the liquid discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particles of the raw material.

The liquid discharge apparatus may also include an apparatus for manufacturing an electrode and an electrochemical element, which is also referred to as an electrode manufacturing apparatus. The electrode manufacturing apparatus is described below.

FIG. 16 is a schematic view of an electrode manufacturing apparatus. An electrode manufacturing apparatus 700 is an apparatus for manufacturing an electrode including a layer containing an electrode material by discharging a liquid composition using a liquid discharge unit including a liquid discharge head.

A description is given below of a device and process for forming a layer containing an electrode material. The liquid discharge device in the electrode manufacturing apparatus 700 illustrated in FIG. 16 is the liquid discharge unit described above. The liquid discharge head of the liquid discharge unit discharges a liquid composition. By so doing, the liquid composition is applied onto an object, and a liquid composition layer is formed on the object. The object, which may also be referred to as a discharge target in the following description, is not limited to any particular object and may be appropriately selected depending on the intended purpose, as long as the object is an object on which a layer containing an electrode material is to be formed. Examples of the object include an electrode substrate, i.e., a current collector, an active material layer, and a layer containing a solid electrode material. The object may be an electrode composite layer containing an active material on an electrode substrate. A discharge device (e.g., a discharge process device 110) and a discharge process may be a device and a process of forming a layer containing an electrode material by directly discharging a liquid composition as long as the layer containing an electrode material can be formed on a discharge target. The discharge device and the discharge process may be a device and a process of forming a layer containing an electrode material by indirectly discharging a liquid composition.

Other configurations and processes are described below. Other configurations included in the electrode manufacturing apparatus for manufacturing an electrode composite layer are not limited to any particular configuration and may be appropriately selected depending on the intended purpose, as long as the effects of the present embodiment are not impaired. Other processes included in the method for manufacturing an electrode composite layer are not limited to any particular process and may be appropriately selected depending on the intended purpose, as long as the effects of the present embodiment are not impaired. For example, a heating device and a heating process are examples of the configuration and the process included in the electrode manufacturing apparatus and the manufacturing method of the electrode composite layer.

The heating device and the heating process are described below. The heating device (e.g., a heating process device 130) included the electrode manufacturing apparatus for manufacturing an electrode composite layer is a device that heats the liquid composition discharged by the discharge device. The heating process included in the manufacturing method for manufacturing an electrode composite layer is a process of heating the liquid composition discharged in the discharge process. The liquid composition is heated to dry the liquid composition layer.

A description is given below of a structure to form a layer containing an electrode material by directly discharging a liquid composition. An electrode manufacturing apparatus, which forms a layer containing an electrode material, is described below. The electrode manufacturing apparatus forms an electrode composite layer containing an active material on an electrode substrate (current collector).

As illustrated in FIG. 16, the electrode manufacturing apparatus 700 includes the discharge process device 110 and the heating process device 130. The discharge process device 110 performs a discharge process of applying a liquid composition onto a print base material 704 having a discharge target to form a liquid composition layer. The heating process device 130 performs a heating process of heating the liquid composition to obtain an electrode composite layer.

The electrode manufacturing apparatus 700 further includes a conveyance unit 705 that conveys the print base material 704. The conveyance unit 705 conveys the print base material 704 to the discharge process device 110 and the heating process device 130 in this order at a preset speed. A method of producing the print base material 704 having the discharge target such as an active material layer is not limited to any particular method, and a known method can be appropriately selected. The discharge process device 110 includes a liquid discharge head 281a that performs an application process of applying the liquid composition onto the print base material 704, a storage container 281b that stores a liquid composition 707, and a supply tube 281c that supplies the liquid composition 707 in the storage container 281b to the liquid discharge head 281a.

The discharge process device 110 discharges the liquid composition 707 from the liquid discharge head 281a so that the liquid composition 707 is applied onto the print base material 704 to form a liquid composition layer in a thin film shape. The storage container 281b may be integrated with the electrode manufacturing apparatus that forms the electrode composite layer or may be detachable from the electrode manufacturing apparatus. The storage container 281b may be a container additionally attachable to a container integrated with the electrode manufacturing apparatus for manufacturing the electrode composite layer or to a container detachable from the electrode manufacturing apparatus for manufacturing the electrode composite layer. The storage container 281b that stably stores the liquid composition 707 and the supply tube 281c that stably supplies the liquid composition 707 can be used.

The heating process device 130 performs a solvent removal process of heating and removing the solvent remaining in the liquid composition layer. Specifically, the solvent that remains in the liquid composition layer is heated and dried by a heater 703 of the heating process device 130 to remove the solvent from the liquid composition layer. Accordingly, the electrode composite layer is formed. The heating process device 130 may perform the solvent removal process under reduced pressure.

The heater 703 is not limited to any particular heater and may be appropriately selected depending on the intended purpose. For example, the heater 703 may be a substrate heater, an infrared (IR) heater, or a hot air heater. The heater 703 may be a combination of at least two of the substrate heater, the IR heater, and the hot air heater. A heating temperature and heating time can be appropriately selected according to the boiling point of the solvent contained in the liquid composition 707 or the thickness of a formed film.

In the electrode manufacturing apparatus 700, a liquid discharge head similar to the liquid discharge head 11 described above is used as the liquid discharge head 281a. The electrode manufacturing apparatus 700 is used to discharge the liquid composition to a desired position on the discharge target. The electrode composite layer can be suitably used, for example, as a part of the configuration of an electrochemical element. The configuration of the electrochemical element other than the electrode composite layer is not limited to any particular configuration, and a known configuration can be appropriately selected. Examples of the configuration other than the electrode composite layer include a positive electrode, a negative electrode, and a separator.

Aspects of the present disclosure are, for example, as follows.

### Aspect 1

A liquid discharge head includes a nozzle substrate. Multiple nozzles are formed on the nozzle substrate. The liquid discharge head discharges liquid droplets from the nozzles onto a recording medium conveyed in a sub-scanning direction and is movable in a main scanning direction orthogonal to the sub-scanning direction. Nozzle arrays include the multiple nozzles arrayed in parallel with the sub-scanning direction, and the nozzle arrays are arrayed in multiple rows in the main scanning direction. The density of the nozzles forming an outer nozzle array which is the nozzle array arranged on an outer side of the nozzle substrate in the main scanning direction is lower than the density of the nozzles forming an inner nozzle array which is the nozzle array arranged on an inner side of the nozzle substrate in the main scanning direction.

In other words, a liquid discharge head includes a nozzle plate having a first nozzle array and a second nozzle array. The first nozzle array has first nozzles to discharge liquid in a discharge direction. The second nozzle array is disposed between the first nozzle array and one edge of the nozzle plate in a first direction orthogonal to the discharge direction. The second nozzle array has second nozzles to discharge the liquid in the discharge direction. The first nozzles of the first nozzle array are: arrayed in a second direction orthogonal to the first direction and the discharge direction; and arrayed at a first nozzle density in the second direction. The second nozzles of the second nozzle array are: arrayed in the second direction; and arrayed at a second nozzle density smaller than the first nozzle density in the second direction.

### Aspect 2

In the liquid discharge head according to Aspect 1, the nozzle plate further has a third nozzle array between the first nozzle array and another edge of the nozzle plate in the first direction. The third nozzle array has third nozzles to discharge the liquid in the discharge direction. The third nozzles of the third nozzle array are: arrayed in the second direction; and arrayed at a third nozzle density equal to the second nozzle density in the second direction.

### Aspect 3

The liquid discharge head according to Aspect 1, further includes another outer nozzle array outside the outer nozzle array. Said another outer nozzle array includes the nozzles formed at the same density as the outer nozzle array. Said another outer nozzle array is different from the outer nozzle array in the position of the nozzles in the main scanning direction. The outer nozzle array and said another outer nozzle array form a desired resolution of an image.

In other words, the nozzle plate further has a third nozzle array between the second nozzle array and the one edge of the nozzle plate in the first direction. The third nozzle array has third nozzles to discharge the liquid in the discharge direction. The third nozzles of the third nozzle array are: arrayed in the second direction; arrayed at a third nozzle density equal to the second nozzle density in the second direction; and shifted from the second nozzles in the second direction.

### Aspect 4

In the liquid discharge head according to Aspect 3, the nozzle substrate has a rectangular shape with all corners chamfered.

In other words, the nozzle plate has a rectangular shape with chamfered corners.

### Aspect 5

In the liquid discharge head according to Aspect 4, when a resolution based on the density of the nozzles forming said another outer nozzle array and the other outer nozzle array is 1/n (n>2) of the desired resolution of the image, said another outer nozzle array is disposed in n−1 rows, and a size of a chamfer increases in proportion to n.

In other words, the nozzle plate further has a (n+1)th nozzle array. The (n+1)th nozzle array is disposed between the third nozzle array and the one edge of the nozzle plate in the first direction. The (n+1)th nozzle array has a (n+1)th nozzle density equal to: 1/n of the first nozzle density; and the second nozzle density and the third nozzle density. A width of the chamfered corners increases in proportion to n, where n is an integer larger than two.

### Aspect 6

In the liquid discharge head according to any one of Aspects 1 to 5, a gap between the outer nozzle array and the inner nozzle array is narrower than an interval between the respective nozzles in the inner nozzle array.

In other words, the second nozzle array is spaced apart from the first nozzle array, in the first direction, by a gap narrower than an interval between the first nozzles in the second direction.

### Aspect 7

In the liquid discharge head according to Aspect 2, the first nozzle array and the third nozzle array are symmetric with respect to a center line: disposed at a center of the nozzle plate in the first direction; and extending in the second direction.

### Aspect 8

A liquid discharge unit includes the liquid discharge head according to any one of Aspects 1 to 7.

In other words, a liquid discharge unit includes the liquid discharge head according to any one of Aspects 1 to 7 and a carriage mounting the liquid discharge head to move the liquid discharge head in the first direction.

Aspect 9

A liquid discharge apparatus includes the liquid discharge head according to any one of Aspects 1 to 7.

In other words, a liquid discharge apparatus includes the liquid discharge head according to any one of Aspects 1 to 7 and a conveyor to convey a medium to the liquid discharge head in the first direction.

Aspect 10

A liquid discharge apparatus includes the liquid discharge unit according to Aspect 8.

In other words, a liquid discharge apparatus includes the liquid discharge unit according to Aspect 8 and a conveyor to convey a medium to the liquid discharge unit in the second direction.

As described above, according to one aspect of the present disclosure, a liquid discharge head can be provided that reduces variations in the landing position of ink due to the influence of airflow, regardless of the moving direction of the head.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head comprising:
a nozzle plate having:
a first nozzle array having first nozzles to discharge liquid in a discharge direction; and
a second nozzle array disposed between the first nozzle array and one edge of the nozzle plate in a first direction orthogonal to the discharge direction,
the second nozzle array having second nozzles to discharge the liquid in the discharge direction,
wherein the first nozzles of the first nozzle array are:
arrayed in a second direction orthogonal to the first direction and the discharge direction; and
arrayed at a first nozzle density in the second direction: and
the second nozzles of the second nozzle array are:
arrayed in the second direction; and
arrayed at a second nozzle density smaller than the first nozzle density in the second direction.

2. The liquid discharge head according to claim 1,
wherein the nozzle plate further has:
a third nozzle array between the first nozzle array and another edge of the nozzle plate in the first direction,
the third nozzle array having third nozzles to discharge the liquid in the discharge direction,
the third nozzles of the third nozzle array are:
arrayed in the second direction; and
arrayed at a third nozzle density equal to the second nozzle density in the second direction.

3. The liquid discharge head according to claim 1,
wherein the nozzle plate further has:
a third nozzle array between the second nozzle array and the one edge of the nozzle plate in the first direction,
the third nozzle array having third nozzles to discharge the liquid in the discharge direction,
the third nozzles of the third nozzle array are:
arrayed in the second direction;
arrayed at a third nozzle density equal to the second nozzle density in the second direction; and
shifted from the second nozzles in the second direction.

4. The liquid discharge head according to claim 3,
wherein the nozzle plate has a rectangular shape with chamfered corners.

5. The liquid discharge head according to claim 4,
wherein the nozzle plate further has a (n+1)th nozzle array,
the (n+1)th nozzle array is disposed between the third nozzle array and the one edge of the nozzle plate in the first direction,
the (n+1)th nozzle array has a (n+1)th nozzle density equal to:
1/n of the first nozzle density; and
the second nozzle density and the third nozzle density, and
a width of the chamfered corners increases in proportion to n,
where n is an integer larger than two.

6. The liquid discharge head according to claim 1,
wherein the second nozzle array is spaced apart from the first nozzle array, in the first direction, by a gap narrower than an interval between the first nozzles in the second direction.

7. The liquid discharge head according to claim 2,
wherein the first nozzle array and the third nozzle array are symmetric with respect to a center line:
disposed at a center of the nozzle plate in the first direction; and
extending in the second direction.

8. A liquid discharge unit comprising:
the liquid discharge head according to claim 1; and
a carriage mounting the liquid discharge head to move the liquid discharge head in the first direction.

9. A liquid discharge apparatus comprising:
the liquid discharge head according to claim 1; and
a conveyor to convey a medium to the liquid discharge head in the first direction.

10. A liquid discharge apparatus comprising:
the liquid discharge unit according to claim 8; and
a conveyor to convey a medium to the liquid discharge unit in the second direction.
